(19) United States
(12) Patent Application Publication
(10) Pub. No.: US 2026/0330692 A1
(43) Pub. Date: Oct. 22, 2026

(54) DYNAMIC MESH COMPRESSION METHOD AND DEVICE

(71) Applicant: INTELLECTUAL DISCOVERY CO., LTD., Seoul (KR)

(72) Inventors: Jongseok LEE, Seoul (KR); Min Sub KIM, Seoul (KR)

(21) Appl. No.: 19/110,388

(22) PCT Filed: Sep. 15, 2023
(86) PCT No.: PCT/KR2023/013958

§ 371 Date: Mar. 10, 2025

(30) Foreign Application Priority Data
Sep. 15, 2022 (KR) 10-2022-0116543
Sep. 15, 2022 (KR) 10-2022-0116544

(51) Int. Cl. G06T 9/00; G06T 15/04; G06T 17/20; H04N 19/597

(52) U.S. Cl. CPC G06T 9/001; G06T 15/04; G06T 17/20; H04N 19/597

(57) ABSTRACT

A mesh compression method and device, according to an embodiment of the present invention, may reconstruct a base mesh on the basis of geometry information obtained from a base mesh bitstream, perform surface division on the reconstructed base mesh, obtain a displacement vector for at least one of a vertex of the reconstructed base mesh and a sub-vertex generated by the surface division, reconstruct an enhancement mesh on the basis of the reconstructed base mesh and the obtained displacement vector, and obtain a texture image associated with the surface of the reconstructed enhancement mesh.

### TECHNICAL FIELD

The present invention relates to a method and a device for video compression encoding and decoding, and more particularly, to a method and a device for video compression encoding and decoding using dynamic mesh compression.

### BACKGROUND ART

Video images are compressed and encoded by removing spatial-temporal redundancy and inter-view redundancy, and can be transmitted through communication lines or stored in a suitable form on a storage medium.

### DISCLOSURE

### Technical Problem

The present invention proposes a displacement vector prediction method and device for dynamic mesh coding.

In this case, a displacement vector prediction method proposed in the present invention is to provide high encoding efficiency by using a motion vector used for inter reference to predict a displacement vector.

In addition, the present invention proposes a frame group unit dynamic mesh coding method and device for dynamic mesh coding.

In this case, a frame group unit dynamic mesh coding method proposed in the present invention is to provide high encoding efficiency by omitting encoding/decoding of an attribute map for a current frame and using a reconstructed attribute map within the same GOF.

### Technical Solution

In order to solve the problem, a dynamic mesh compression method and device using displacement vector prediction are proposed. In addition, a frame group unit dynamic mesh compression method and device are proposed to solve the problem.

A mesh compression method and device according to an embodiment of the present invention may reconstruct a base mesh based on geometry information obtained from a base mesh bitstream, perform surface division on the reconstructed base mesh, obtain a displacement vector for at least one of a vertex of the reconstructed base mesh and a sub-vertex generated by the surface division, reconstruct an enhancement mesh based on the reconstructed base mesh and the obtained displacement vector and obtain a texture image associated with a surface of the reconstructed enhancement mesh.

In a mesh compression method and device according to an embodiment of the present invention, the geometry information may be coded based on a first prediction mode, the displacement vector may be coded based on a second prediction mode and the texture image may be coded based on a third prediction mode.

In a mesh compression method and device according to an embodiment of the present invention, the first prediction mode, the second prediction mode and the third prediction mode may be one of an inter prediction mode or an intra prediction method.

In a mesh compression method and device according to an embodiment of the present invention, at least one of the first prediction mode, the second prediction mode or the third prediction mode may be determined in a predetermined coding unit.

In a mesh compression method and device according to an embodiment of the present invention, the coding unit may be at least one of a frame, a patch, a surface or a vertex.

A mesh compression method and device according to an embodiment of the present invention may reconstruct a current frame based on the reconstructed enhancement mesh and the texture image.

A mesh compression method and device according to an embodiment of the present invention may obtain a first flag indicating whether texture image compression is used for the current frame.

In a mesh compression method and device according to an embodiment of the present invention, the first flag may be signaled in a frame group unit including at least one frame.

In a mesh compression method and device according to an embodiment of the present invention, when the texture image compression is used for the current frame, the texture image may be obtained by referring to the texture image of a frame coded before the current frame.

A mesh compression method and device according to an embodiment of the present invention may obtain a second flag indicating whether to code a texture image for the current frame.

In a mesh compression method and device according to an embodiment of the present invention, the second flag may be signaled in a frame unit.

In a mesh compression method and device according to an embodiment of the present invention, when coding of a texture image for the current frame is omitted, the texture image may be obtained by referring to a texture image of a frame that a picture order count (POC) value is closest to the current frame among frames coded before the current frame.

A mesh compression method and device according to an embodiment of the present invention may obtain a texture index indicating a texture image in a texture video including a plurality of texture images.

A mesh compression device according to an embodiment of the present invention may include a processor that controls the mesh compression device and a memory that is combined with the processor and stores data, and the processor may reconstruct a base mesh based on geometry information obtained from a base mesh bitstream, perform surface division on the reconstructed base mesh, obtain a displacement vector for at least one of a vertex of the reconstructed base mesh and a sub-vertex generated by the surface division, reconstruct an enhancement mesh based on the reconstructed base mesh and the obtained displacement vector and obtain a texture image associated with a surface of the reconstructed enhancement mesh.

### Technical Effect

According to a displacement vector prediction method proposed in the present invention, high encoding efficiency may be provided by using a motion vector used for inter reference to predict a displacement vector.

According to a frame group unit dynamic mesh coding method proposed in the present invention, high encoding efficiency may be provided by omitting encoding/decoding of an attribute map for a current frame and using a reconstructed attribute map within the same group of frame (GOF).

### BRIEF DESCRIPTION OF DRAWINGS

FIG. 1 shows an example of a mesh encoder and decoder according to an embodiment of the present disclosure.

FIG. 2 shows an example of a base mesh geometry information encoding unit according to an embodiment of the present disclosure.

FIG. 3 shows an example of an enhancement mesh geometry information encoding unit according to an embodiment of the present disclosure.

FIG. 4 shows an example of a mesh attribute information encoding unit according to an embodiment of the present disclosure.

FIG. 5 shows an example of a base mesh geometry information decoding unit according to an embodiment of the present disclosure.

FIG. 6 shows an example of an enhancement mesh geometry information decoding unit according to an embodiment of the present disclosure.

FIG. 7 shows an example of a mesh attribute information decoding unit according to an embodiment of the present disclosure.

FIG. 8 is a diagram illustrating a mid-point-based surface division method according to an embodiment of the present disclosure.

FIG. 9 is a diagram for describing a displacement vector according to an embodiment of the present disclosure.

FIG. 10 is a diagram illustrating a coefficient scanning method of an image packing unit according to an embodiment of the present disclosure.

FIG. 11 is a diagram illustrating an enhancement mesh geometry information encoding unit according to an embodiment of the present disclosure.

FIG. 12 is a diagram illustrating an enhancement mesh geometry information decoding unit according to an embodiment of the present disclosure.

FIG. 13 is a diagram illustrating a displacement vector prediction method according to an embodiment of the present disclosure.

FIG. 14 is a diagram illustrating an encoding/decoding order and reference structure of base mesh geometry information, a displacement vector image and a texture image according to an embodiment of the present disclosure.

FIG. 15 is a diagram illustrating an encoding/decoding process of a texture video according to an embodiment of the present disclosure.

FIG. 16 is a diagram illustrating an encoding/decoding process of a texture video according to an embodiment of the present disclosure.

FIG. 17 is a diagram illustrating an encoding/decoding process of a texture video according to an embodiment of the present disclosure.

FIG. 18 is a flowchart illustrating a mesh compression process according to an embodiment of the present disclosure.

### BEST MODE

In order to solve the problem, a dynamic mesh compression method and device using displacement vector prediction are proposed. In addition, a frame group unit dynamic mesh compression method and device are proposed to solve the problem.

A mesh compression method and device according to an embodiment of the present invention may reconstruct a base mesh based on geometry information obtained from a base mesh bitstream, perform surface division on the reconstructed base mesh, obtain a displacement vector for at least one of a vertex of the reconstructed base mesh and a sub-vertex generated by the surface division, reconstruct an enhancement mesh based on the reconstructed base mesh and the obtained displacement vector and obtain a texture image associated with a surface of the reconstructed enhancement mesh.

In a mesh compression method and device according to an embodiment of the present invention, the geometry information may be coded based on a first prediction mode, the displacement vector may be coded based on a second prediction mode and the texture image may be coded based on a third prediction mode.

In a mesh compression method and device according to an embodiment of the present invention, the first prediction mode, the second prediction mode and the third prediction mode may be one of an inter prediction mode or an intra prediction method.

In a mesh compression method and device according to an embodiment of the present invention, at least one of the first prediction mode, the second prediction mode or the third prediction mode may be determined in a predetermined coding unit.

In a mesh compression method and device according to an embodiment of the present invention, the coding unit may be at least one of a frame, a patch, a surface or a vertex.

A mesh compression method and device according to an embodiment of the present invention may reconstruct a current frame based on the reconstructed enhancement mesh and the texture image.

A mesh compression method and device according to an embodiment of the present invention may obtain a first flag indicating whether texture image compression is used for the current frame.

In a mesh compression method and device according to an embodiment of the present invention, the first flag may be signaled in a frame group unit including at least one frame.

In a mesh compression method and device according to an embodiment of the present invention, when the texture image compression is used for the current frame, the texture image may be obtained by referring to the texture image of a frame coded before the current frame.

A mesh compression method and device according to an embodiment of the present invention may obtain a second flag indicating whether to code a texture image for the current frame.

In a mesh compression method and device according to an embodiment of the present invention, the second flag may be signaled in a frame unit.

In a mesh compression method and device according to an embodiment of the present invention, when coding of a texture image for the current frame is omitted, the texture image may be obtained by referring to a texture image of a frame that a picture order count (POC) value is closest to the current frame among frames coded before the current frame.

A mesh compression method and device according to an embodiment of the present invention may obtain a texture index indicating a texture image in a texture video including a plurality of texture images.

A mesh compression device according to an embodiment of the present invention may include a processor that controls the mesh compression device and a memory that is combined with the processor and stores data, and the processor may reconstruct a base mesh based on geometry information obtained from a base mesh bitstream, perform surface division on the reconstructed base mesh, obtain a displacement vector for at least one of a vertex of the reconstructed base mesh and a sub-vertex generated by the surface division, reconstruct an enhancement mesh based on the reconstructed base mesh and the obtained displacement vector and obtain a texture image associated with a surface of the reconstructed enhancement mesh.

### Mode

An embodiment of the present disclosure will be described in detail so that those skilled in the art may easily implement it by referring to a drawing attached to this specification. But, the present disclosure may be implemented in different forms and it is not limited to an embodiment described herein. And, a part irrelevant to a description is omitted to clearly describe the present disclosure in a drawing and a similar reference numeral is attached to a similar part throughout this specification.

Throughout this specification, when a part is referred to as being ‘connected’ to other part, it may include an electrical connection that other element presents therebetween as well as a direct connection.

In addition, when a part is referred to as ‘including’ a component throughout this specification, it means other component may be further included without excluding other component unless otherwise opposed.

In addition, a term such as first, second, etc. may be used to describe a variety of components, but the components should not be limited by the terms. The terms are used only to distinguish one component from other component.

In addition, for an embodiment about a device and a method described in this specification, some configurations of a device or some steps of a method may be omitted. In addition, order of some configurations of a device or some steps of a method may be changed. In addition, other configuration or other step may be inserted into some configurations of a device or some steps of a method.

In addition, some configurations or some steps of a first embodiment of the present disclosure may be added to a second embodiment of the present disclosure or may substitute some configurations or some steps of a second embodiment.

In addition, construction units shown in an embodiment of the present disclosure are independently shown to represent different characteristic functions, and they do not mean that each construction unit is configured with separated hardware or one software construction unit. In other words, each construction unit is described by being enumerated as each construction unit for convenience of a description and at least two construction units of each construction unit may be combined to form one construction unit or one construction unit may be partitioned into a plurality of construction units to perform a function. An integrated embodiment and separated embodiment of each construction unit are also included in a scope of a right of the present disclosure unless they are departing from the spirit of the present disclosure.

First, terms used in this application may be briefly described as follows.

A decoding device (Video Decoding Apparatus) to be described later may be a device included in a server terminal such as a civil security camera, a civil security system, a military security camera, a military security system, a personal computer (PC), a notebook computer, a portable multimedia player (PMP), a wireless communication terminal, a smart phone, a TV application server and a service server, etc. and it may mean a variety of devices equipped with a user terminal including equipment of every kind, a communication device including a communication modem, etc. for communication with a wired/wireless communication network, a memory for storing various kinds of programs and data for decoding an image or performing intra or inter prediction for decoding, a microprocessor for executing a program and performing operation and control and others.

In addition, an image encoded as a bitstream by an encoder may be transmitted to an image decoding device, decoded and reconstructed and reproduced as an image through a variety of communication interface such as a cable, an universal serial bus (USB), etc. or through a wired or wireless communication network, etc. such as the Internet, a wireless local area network, a wireless LAN network, a Wi-Bro network, a mobile communication network, etc. in real time or in non-real time. Alternatively, a bitstream generated by an encoder may be stored in a memory. The memory may include both a volatile memory and a non-volatile memory. In this specification, a memory may be expressed as a recoding medium storing a bitstream.

Commonly, a video may be configured with a series of pictures and each picture may be partitioned into coding units like a block. In addition, a person with ordinary skill in the art to which this embodiment pertains may understand that a term of picture entered below may be used by being substituted with other term having the same meaning as an image, a frame, etc. And, a person with ordinary skill in the art to which this embodiment pertains may understand that a term of coding unit may be used by being substituted with other term having the same meaning as a unit block, a block, etc.

Hereinafter, in reference to attached drawings, an embodiment of the present disclosure is described in more detail. In describing the present disclosure, an overlapping description is omitted for the same component.

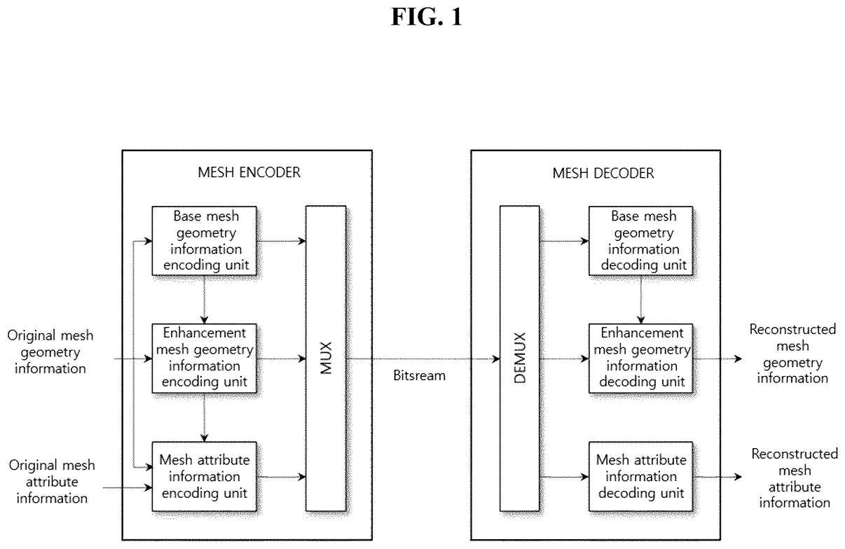

FIG. 1 shows an example of a mesh encoder and decoder according to an embodiment of the present disclosure.

Referring to FIG. 1, a mesh encoder may receive original mesh geometry information and original mesh attribute information to generate a bitstream. A mesh decoder may receive a bitstream to reconstruct mesh geometry information and attribute information.

Here, mesh geometry information may include three-dimensional coordinate information of a mesh vertex, a two-dimensional coordinate of a mesh texture vertex and connection information of vertices. In addition, mesh attribute information may be a texture map. A texture map may include a plurality of channels. As an example, a texture map may be an image having at least three two-dimensional channels. In this case, a channel may mean one color space of RGB, YUV, YCbCr, YCoCg and YCgCo. Alternatively, a channel may mean a color space of RGBA. In other words, mesh attribute information may include color information of an external surface of a three-dimensional object.

A mesh encoder may include a base mesh geometry information encoding unit, an enhancement mesh geometry information encoding unit, a mesh attribute information encoding unit and a multiplexer (MUX).

A base mesh geometry information encoding unit may receive original mesh geometry information to generate a base mesh geometry information bitstream and reconstructed base mesh geometry information or a base mesh geometry information bitstream and reconstructed base mesh geometry information and a motion vector. A generated base mesh geometry information bitstream may be transmitted to a MUX. In addition, generated reconstructed base mesh geometry information may be transmitted to an enhancement mesh geometry information encoding unit. In addition, a generated reconstructed motion vector may be transmitted to an enhancement mesh geometry information encoding unit.

An enhancement mesh geometry information encoding unit may receive reconstructed base mesh geometry information and original mesh geometry information and perform encoding to generate a bitstream and reconstructed mesh geometry information. A generated enhancement mesh bitstream may be transmitted to a MUX. In addition, reconstructed mesh geometry information may be transmitted to a mesh attribute information encoding unit.

A mesh attribute information encoding unit may receive and encode original mesh geometry information, original mesh attribute information and reconstructed mesh geometry information to generate a mesh attribute information bitstream. A generated mesh attribute information bitstream may be transmitted to a MUX.

A MUX may connect all input bitstreams and output them in the form of a single bitstream.

A mesh decoder may include a demultiplexer (DEMUX), a base mesh geometry information decoding unit, an enhancement mesh geometry information decoding unit and a mesh attribute information decoding unit.

A DEMUX may separate an input bitstream into a base mesh geometry information bitstream, an enhancement mesh geometry information bitstream and a mesh attribute information bitstream and transmit them to a base mesh geometry information decoding unit, an enhancement mesh geometry information decoding unit and a mesh attribute information decoding unit, respectively.

A base mesh geometry information decoding unit may decode an input base mesh geometry information decoding unit to reconstruct base mesh geometry information. Reconstructed base mesh geometry information may be transmitted to an enhancement mesh geometry information decoding unit.

An enhancement mesh geometry information decoding unit may receive and decode an enhancement mesh geometry information bitstream and reconstructed base mesh geometry information and reconstruct mesh geometry information to output it from a mesh decoding unit.

A mesh attribute information decoding unit may receive and decode a mesh attribute information bitstream and reconstruct mesh attribute information to output it from a mesh decoding unit.

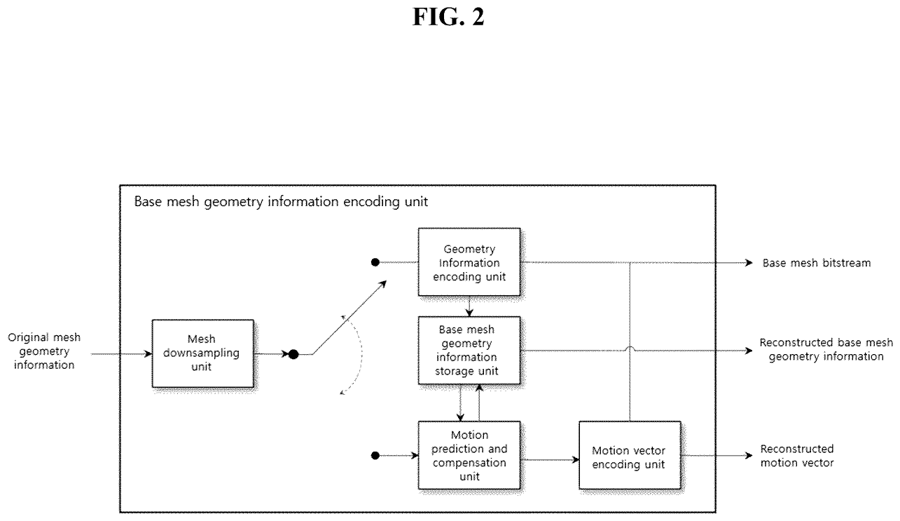

FIG. 2 shows an example of a base mesh geometry information encoding unit according to an embodiment of the present disclosure.

Referring to FIG. 2, a base mesh geometry information encoding unit may receive original mesh geometry information, perform encoding and output a base mesh bitstream, reconstructed base mesh geometry information and a reconstructed motion vector.

A base mesh geometry information encoding unit may include a mesh downsampling unit, a geometry information encoding unit, a base mesh geometry information storage unit, a motion prediction and compensation unit and a motion vector encoding unit.

A mesh downsampling unit may receive original mesh geometry information, perform downsampling of geometry information and generate downsampled mesh geometry information. Here, a downsampled mesh may be referred to as a base mesh. In addition, input original mesh geometry information may be preprocessed to have the same number of vertices and connections when mesh downsampling is performed and mesh surface division is performed thereafter. Generated base mesh geometry information may be transmitted to a geometry information encoding unit and a motion prediction and compensation unit. Alternatively, it may be transmitted to a geometry information encoding unit or a motion prediction and compensation unit based on a prediction mode. Here, a prediction mode may mean intra prediction or inter prediction and corresponding information may be transmitted to a decoder through entropy encoding.

A geomety information encoding unit may receive base mesh geometry information and perform encoding to generate a base mesh bitstream. In addition, reconstructed base mesh geometry information may be generated. In this case, a geometry information encoding unit may perform encoding on the three-dimensional vertex coordinate of a mesh, a two-dimensional texture vertex coordinate and connectivity between vertices. In addition, a geometry information encoding unit may use an international standard mesh geometry information compression method such as MPEG-AFX/TFAN and Google Draco. Accordingly, information about a mesh compression method used in a geometry information encoding unit may be transmitted to a decoder through entropy encoding. A generated base mesh bitstream may be output from a base mesh geometry information encoding unit. Reconstructed base mesh geometry information may be transmitted to a base mesh geometry information storage unit.

A motion prediction and compensation unit may receive base mesh geometry information and reconstructed base mesh geometry information and perform motion prediction to generate a motion vector. In addition, the reconstructed base mesh geometry information of a previous frame may be motion-compensated by using a motion vector to generate the reconstructed base mesh geometry information of a current frame. A generated motion vector may be transmitted to a motion vector encoding unit. In addition, the reconstructed base mesh geometry information of a current frame may be transmitted to a base mesh geometry information storage unit and a motion vector encoding unit.

A motion vector encoding unit may generate a base mesh bitstream from an input motion vector by using reconstructed base mesh geometry information. Here, one vertex may have at least one motion vector and each motion vector may be a vector having at least one dimension. In this case, a size value for each dimension of a motion vector may be sequentially encoded. For example, the size value of a first dimension of a motion vector of all vertices of a base mesh may be entropy-encoded in order. In this case, order may be the traversal order of vertices determined based on the vertex and connectivity of a base mesh. After the first dimension encoding of a motion vector of all vertices, the size value of a second dimension of a motion vector may be encoded. In this way, the motion vector of all dimensions may be encoded sequentially while increasing a dimension index. As another example, a motion vector encoding unit may encode a motion vector in the vertex unit of a reconstructed base mesh. According to the vertex traversal order, encoding may be performed in the order of a first dimension size, a second dimension size and a third dimension size of a motion vector of each vertex and then, encoding may be performed for the motion vector of the next vertex. Here, as a method for encoding a motion vector, when a motion vector corresponding to a current vertex is encoded, a reconstructed motion vector corresponding to a reconstructed neighbor vertex may be used to predict a motion vector and encode the size value of each dimension of that difference vector. A generated base mesh bitstream may be output from a base mesh geometry information encoding unit. In addition, reconstructed base mesh geometry information may be output from a base mesh geometry information encoding unit.

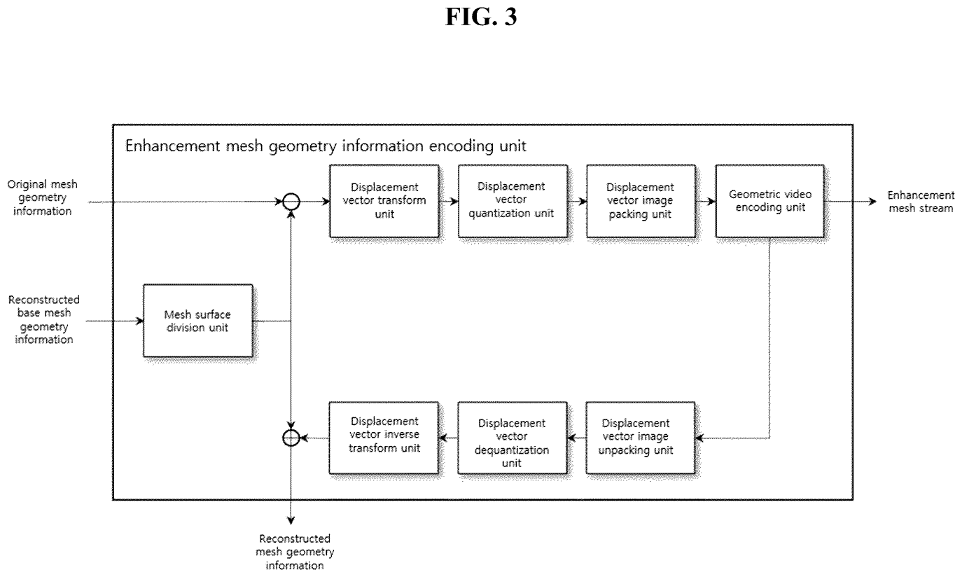

FIG. 3 shows an example of an enhancement mesh geometry information encoding unit according to an embodiment of the present disclosure.

Referring to FIG. 3, an enhancement mesh geometry information encoding unit may receive original mesh geometry information and reconstructed base mesh geometry information and perform encoding to generate an enhancement mesh bitstream and reconstructed mesh geometry information.

An enhancement mesh geometry information encoding unit may have a mesh surface division unit, a displacement vector transform unit, a displacement vector quantization unit, a displacement vector image packing unit, a geometric video encoding unit, a displacement vector image unpacking unit, a displacement vector dequantization unit and a displacement vector inverse transform unit.

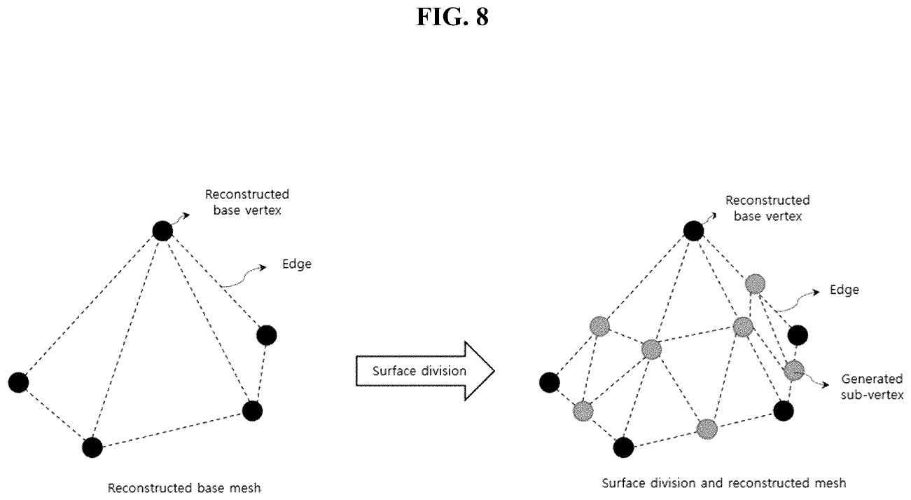

A mesh surface division unit may receive reconstructed base mesh geometry information and divide a mesh surface to generate divided mesh geometry information. Here, a mid-point division method may be used as one of the surface division methods. A surface division method may be performed multiple times and the number of divisions may be transmitted to a decoder through entropy encoding. A related embodiment is described in detail later in FIG. 8.

Divided mesh geometry information may be input to a displacement vector transform unit in the form of a displacement vector by being subtracted from input original mesh geometry information. In addition, divided mesh geometry information may be output from an enhancement mesh geometry information encoding unit in the form of reconstructed mesh geometry information by being combined with a reconstructed displacement vector generated from a displacement vector inverse transform unit.

A displacement vector transform unit may transform an input displacement vector to generate a displacement vector transform coefficient. In this case, transform may be performed repeatedly multiple times. Alternatively, transform may be performed hierarchically. Wavelet transform may be used as an example of hierarchical transform. Alternatively, graph-based wavelet transform may be used as a type of wavelet transform. Graph-based wavelet transform is also called lifting transform, and may be a method for performing prediction and update by using vertices connected to a current vertex when performing transform for a current vertex. In addition, transform may be performed by dimension of a displacement vector. Alternatively, transform may be performed after dimensionally transforming a three-dimensional displacement vector into one dimension. A generated displacement vector transform coefficient may be transmitted to a displacement vector quantization unit.

A displacement vector quantization unit may receive a transform coefficient and perform quantization to generate a quantized transform coefficient. In this case, if a hierarchical transform method is used in a displacement vector transform unit, a different quantization parameter may be used for each layer. A quantization parameter used for quantization may be transmitted to a decoder through entropy encoding. A generated quantized transform coefficient may be transmitted to a displacement vector image packing unit.

A displacement vector image packing unit may generate a displacement vector image by packing a transmitted quantized displacement vector transform coefficient in the form of an image. A method for packing transform coefficients into an image may sequentially pack a displacement vector transform coefficient corresponding to a corresponding vertex into an image while traversing vertices. In this case, a method for traversing a vertex may use the same traversal order as a method used in the geometry information encoding unit of a base mesh encoding unit. Alternatively, information on a used traversal method may be transmitted to a decoder through entropy encoding.

As an embodiment, depth-first traversal and prediction-degree traversal methods may be used as a traversal method. A depth-first traversal method may be a method for traversing vertices on the right side based on the edge of a specific mesh and then, traversing vertices on the left side. A prediction-degree traversal method is a method for determining the traversal order based on the number of reconstructed neighbor vertices connected to a specific vertex. For example, since all of the initial vertices do not have a reconstructed neighbor vertex, one specific vertex may be encoded/decoded. Afterwards, vertices neighboring a reconstructed vertex become the next traversal order because the number of reconstructed neighbor vertices is 1. Afterwards, all vertices may be traversed by checking the number of vertices repeatedly and increasing it from 1. And, the order of packing into an image may be packed in raster scan order. In this case, the size information of an image to be packed may be transmitted to a decoder through entropy encoding. In this case, the size information of an image may have at least one information among the width, height and number of channels of an image. Alternatively, it may be packed in Z-scan order in a block unit. In this case, the size information of a block may be transmitted to a decoder through entropy encoding. Here, the size information of a block may have at least one of a width and a height. A generated displacement vector image may be transmitted to a geometric video encoding unit.

A geometric video encoding unit may collect an input displacement vector image, receive it in the form of a video, perform encoding and generate an enhancement mesh bitstream. In addition, a reconstructed displacement vector image may be generated. Here, a geometric video encoding unit may use an international standard video compression technology such as H.264/AVC, H.265/HEVC, H.266/VVC, VP8, VP9, AV1, etc. and transmit information about a used video compression technology to a decoder through entropy encoding. A generated enhancement mesh bitstream may be output from an enhancement mesh geometry information encoding unit. In addition, a generated reconstructed displacement vector image may be transmitted to a displacement vector image unpacking unit.

A displacement vector image unpacking unit may unpack an input displacement vector image and reconstruct a quantized displacement vector transform coefficient. In this case, a displacement vector image unpacking unit may use the same method as a vertex traversal information and image scan method used in a displacement vector image packing unit. A generated quantized displacement vector transform coefficient may be transmitted to a displacement vector dequantization unit.

A displacement vector dequantization unit may perform dequantization by receiving an input quantized displacement vector transform coefficient to reconstruct a displacement vector transform coefficient. In this case, dequantization may use the same quantization parameter as a quantization parameter used in a displacement vector quantization unit. Alternatively, it may be transformed to a dequantization parameter corresponding to a quantization parameter used in a displacement vector quantization unit and used. In general, a quantization parameter and a dequantization parameter may be inversely related. Alternatively, dequantization may be performed by using a value scaled based on a quantization parameter. A reconstructed displacement vector transform coefficient may be transmitted to a displacement vector inverse transform unit.

A displacement vector inverse transform unit may reconstruct a displacement vector by inversely transforming an input reconstructed displacement vector transform coefficient. In this case, a transform method used in displacement vector inverse transform may be corresponding inverse transform in a transform method used in a displacement vector transform unit. A reconstructed displacement vector may be combined with divided mesh geometry information generated from a mesh surface dividion unit to reconstruct mesh geometry information and may be output from an enhancement mesh geometry information encoding unit.

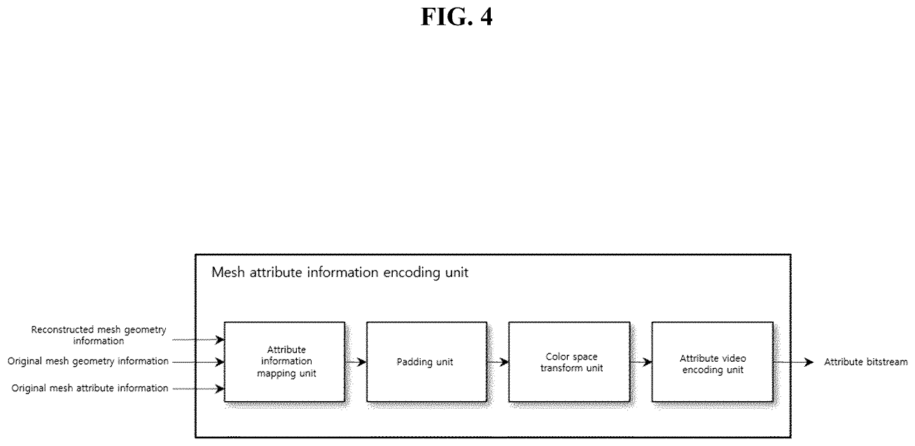

FIG. 4 shows an example of a mesh attribute information encoding unit according to an embodiment of the present disclosure.

Referring to FIG. 4, a mesh attribute information encoding unit may receive reconstructed mesh geometry information, original mesh geometry information and original mesh attribute information and encode original mesh attribute information to generate an attribute bitstream.

A mesh attribute information encoding unit may include an attribute information mapping unit, a padding unit, a color space transform unit and an attribute video encoding unit.

An attribute information mapping unit may receive reconstructed mesh geometry information, original mesh geometry information and original mesh attribute information and map the attribute information of an original mesh to reconstructed mesh geometry information based on the geometry information of a corresponding original mesh to generate a texture map. In other words, the geometry information of a reconstructed mesh and the geometry information of an original mesh express the same three-dimensional object, but a difference may occur due to geometry information encoding/decoding. Accordingly, an attribute information mapping unit may be a process of mapping a texture map to match reconstructed mesh geometry information. For example, a two-dimensional texture vertex corresponding to the three-dimensional coordinate of a triangular face of an original mesh closest to the vertex of reconstructed mesh geometry information may be obtained and the attribute information of a corresponding texture vertex may be mapped to the texture map of a reconstructed mesh. Alternatively, three texture vertices of a triangular face of an original mesh closest to the vertex of reconstructed mesh geometry information may be used to map the triangular attribute information of a corresponding texture map to the texture map of a reconstructed mesh. A generated texture map may be transmitted to a padding unit.

A padding unit may perform padding on a texture map region that is not included in the texture vertex and triangle of reconstructed geometry information for an input texture map. In this case, a fixed padding method for filling everything with a specific value may be used as a padding method. For example, the intermediate value of a bit depth of a texture map may be used. Another method is a push-pull padding method. A push-pull padding method may be a method for downsampling a texture map and upsampling it again to fill an empty space by synthesizing it with an original image. In this case, the number of downsampling and upsampling may be greater than or equal to 1. Another method may be a closest point pixel padding method. It may be a method for padding with the value of a texture vertex closest to each pixel position of an empty space. A padded texture map may be transmitted to a color space transform unit.

A color space transform unit may perform color space transform on an input padded texture map. In this case, color space transform may be RGB-YUV, RGB-YCbCr, RGB-YCoCg or RGB-YCgCo transform. In this case, when a texture map has 4 channels, the color space transform may not be performed, so color space transform may be performed on the remaining channels except for a channel representing transparency. In addition, a transform method used for color space transform may be transmitted to a decoder through entropy encoding. A color space transformed texture map may be transmitted to an attribute video encoding unit.

An attribute video encoding unit may generate an attribute bitstream by gathering input color space transformed texture maps and encoding them in the form of a video. Here, an attribute video encoding unit may use an international standard video compression technology such as H.264/AVC, H.265/HEVC, H.266/VVC, VP8, VP9, AV1, etc. and transmit information about a used video compression technology to a decoder through entropy encoding. A generated attribute bitstream may be output from a mesh attribute encoding unit.

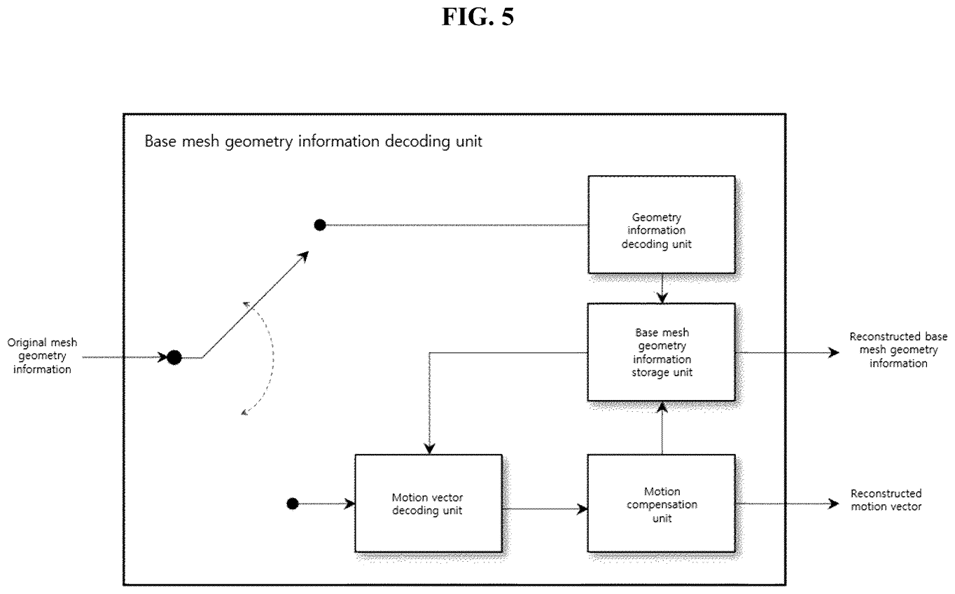

FIG. 5 shows an example of a base mesh geometry information decoding unit according to an embodiment of the present disclosure.

Referring to FIG. 5, a base mesh geometry information decoding unit may receive and decode a base mesh bitstream to generate reconstructed base mesh geometry information and a reconstructed motion vector.

A base mesh geometry information decoding unit may include a geometry information decoding unit, a base mesh geometry information storage unit, a motion vector decoding unit and a motion compensation unit.

A base mesh bitstream which is an input of a base mesh geometry information decoding unit may be transmitted to a geometry information decoding unit or a motion vector decoding unit according to a prediction mode transmitted as higher-level information from a base mesh geometry information encoding unit. For example, when a prediction mode is intra prediction, a base mesh bitstream may be transmitted to a geometry information decoding unit. In the opposite case, it may be transmitted to a motion vector decoding unit.

A geometry information decoding unit may reconstruct an input base mesh bitstream to reconstruct base mesh geometry information. Reconstructed base mesh geometry information may be transmitted to a base mesh geometry information storage unit. In this case, a geometry information decoding unit may use a decoding method corresponding to a method used in the geometry information encoding unit of a base mesh geometry information encoding unit.

A base mesh geometry information storage unit may output the reconstructed base mesh geometry information of an input current frame and store it for use in decoding a subsequent frame. Stored base mesh geometry information may be output from a base mesh geometry information decoding unit. In addition, it may be transmitted to a motion vector decoding unit.

A motion vector decoding unit may reconstruct a motion vector by using an input base mesh bitstream and reconstructed base mesh geometry information. A motion vector may be reconstructed based on the traversal order used when encoding/decoding reconstructed base mesh geometry information. Alternatively, a base mesh bitstream may be decoded to reconstruct a residual motion vector and a motion vector may be reconstructed by adding the motion vector of reconstructed neighbor vertices to a predicted motion vector. A reconstructed motion vector and reconstructed base mesh geometry information may be transmitted to a motion compensation unit.

A motion compensation unit may reconstruct base mesh geometry information by performing motion compensation on input base mesh geometry information by using an input motion vector. In this case, motion compensation may be performed on the three-dimensional coordinate of a vertex of reconstructed mesh geometry information. Reconstructed base mesh geometry information may be transmitted to a base mesh geometry information storage unit. In addition, a reconstructed motion vector may be output from a base mesh geometry information decoding unit.

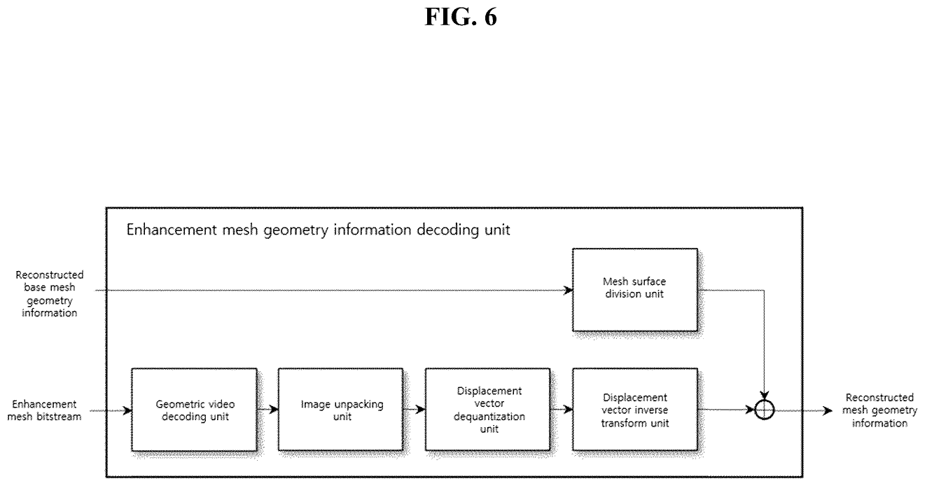

FIG. 6 shows an example of an enhancement mesh geometry information decoding unit according to an embodiment of the present disclosure.

Referring to FIG. 6, an enhancement mesh geometry information decoding unit may receive reconstructed base mesh geometry information and an enhancement mesh bitstream to reconstruct mesh geometry information.

An enhancement mesh geometry information decoding unit may include a mesh surface division unit, a geometric video decoding unit, an image unpacking unit, a displacement vector dequantization unit and a displacement vector inverse transform unit.

A mesh surface division unit may receive reconstructed base mesh geometry information and divide a mesh surface to generate divided mesh geometry information. A base mesh division method may be a method received from an enhancement mesh geometry information encoding unit. In this case, when a division method is performed hierarchically, the number of repetitions may be additionally received from an encoder to perform division for the corresponding number of times. Divided mesh geometry information may be combined with a reconstructed displacement vector generated from a reconstructed vector inverse transform unit and output from an enhancement mesh geometry information decoding unit in the form of reconstructed mesh geometry information.

A geometric video decoding unit may receive an enhancement mesh bitstream, reconstruct a displacement vector video and output it frame by frame in the form of a displacement vector image. In this case, video decoding may be performed based on information about a geometric video compression method received from an enhancement mesh geometry information decoding unit. A geometric video decoding unit may use an international standard video compression technology such as H.264/AVC, H.265/HEVC, H.266/VVC, VP8, VP9, AV1, etc. A reconstructed displacement vector image may be transmitted to a displacement vector image unpacking unit.

A displacement vector image unpacking unit may unpack an input displacement vector image and reconstruct a quantized displacement vector transform coefficient. In this case, a displacement vector image unpacking unit may use the same method as a vertex traversal information and image scanning method used in the displacement vector image packing unit of an enhancement mesh geometry information encoding unit. Alternatively, a vertex traversal information and image scanning method received from an enhancement mesh geometry information encoding unit may be used. A generated quantized displacement vector transform coefficient may be transmitted to a displacement vector dequantization unit.

A displacement vector dequantization unit may perform dequantization by receiving an input quantized displacement vector transform coefficient to reconstruct a displacement vector transform coefficient. In this case, dequantization may use the same quantization parameter as a quantization parameter used in the displacement vector quantization unit of an enhancement mesh geometry information encoding unit. Alternatively, a quantization parameter received from an enhancement mesh geometry information encoding unit may be used. In this case, instead of using a quantization parameter as it is, it may be used by being transformed into a dequantization parameter corresponding to an input quantization parameter. Alternatively, dequantization may be performed by using a value scaled based on a quantization parameter. A reconstructed displacement vector transform coefficient may be transmitted to a displacement vector inverse transform unit.

A displacement vector inverse transform unit may reconstruct a displacement vector by inversely transforming an input reconstructed displacement vector transform coefficient. In this case, a transform method used for displacement vector inverse transform may be the corresponding inverse transform of a transform method used in the displacement vector transform unit of an enhancement mesh geometry information encoding unit. Alternatively, an inverse transform method received from an enhancement mesh encoding unit may be used. Alternatively, an inverse transform method corresponding to a received transform method may be used. A reconstructed displacement vector may be combined with divided mesh geometry information generated from a mesh surface division unit to reconstruct mesh geometry information and may be output from an enhancement mesh geometry information decoding unit.

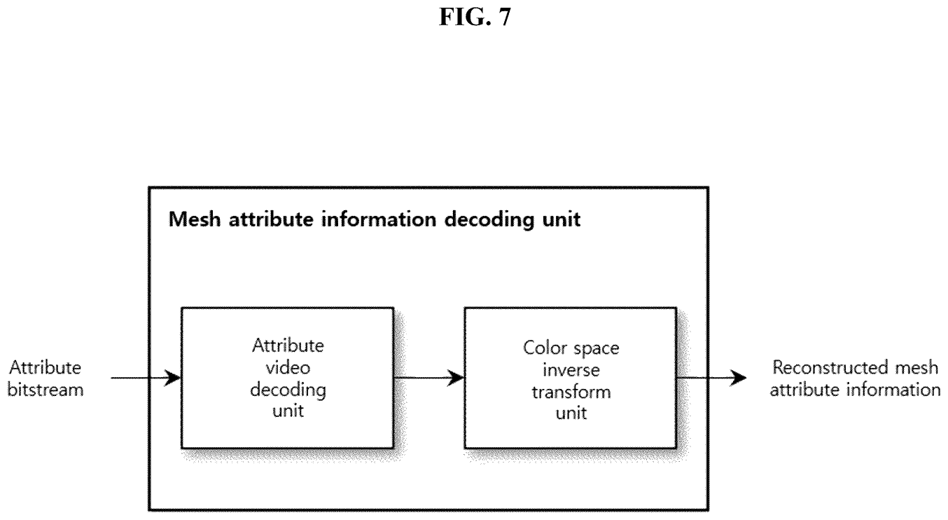

FIG. 7 shows an example of a mesh attribute information decoding unit according to an embodiment of the present disclosure.

Referring to FIG. 7, a mesh attribute information decoding unit may receive and decode an attribute bitstream to reconstruct mesh attribute information.

A mesh attribute information decoding unit may include an attribute information decoding unit and a color space inverse transform unit.

An attribute video decoding unit may reconstruct an attribute bitstream to generate a texture video, output one frame at a time and transmit a reconstructed texture image to a color space inverse transform unit. In this case, an attribute video decoding unit may perform video decoding by using a video compression method received from an attribute video encoding unit.

A color space inverse transform unit may perform color space inverse transform on an input reconstructed texture image to reconstruct mesh attribute information. In this case, for a color space inverse transform method, an inverse transform method corresponding to a color space transform method used in the color space transform unit of a mesh attribute information encoding unit may be used. Alternatively, an inverse transform method received from a mesh attribute information encoding unit may be used. Alternatively, an inverse transform method corresponding to a transform method received from a mesh attribute information encoding unit may be used.

FIG. 8 is a diagram illustrating a mid-point-based surface division method according to an embodiment of the present disclosure.

According to an embodiment of the present disclosure, a sub-vertex may be generated at the center of an edge connecting a vertex and a vertex and surface division may be performed by connecting generated sub-vertices.

Referring to FIG. 8, reconstructed base mesh geometry information may be expressed as a triangle mesh as shown on the left of FIG. 8. In this case, when mid-point division is performed, a sub-vertex may be generated at the center of each edge of a triangle. By connecting generated vertices to each other, one triangle may be divided into four small triangles (or sub-triangles).

In an embodiment, a mid-point-based surface division method may be performed hierarchically (or recursively) and the number of divisions or repetitions may be transmitted to a decoder through entropy encoding.

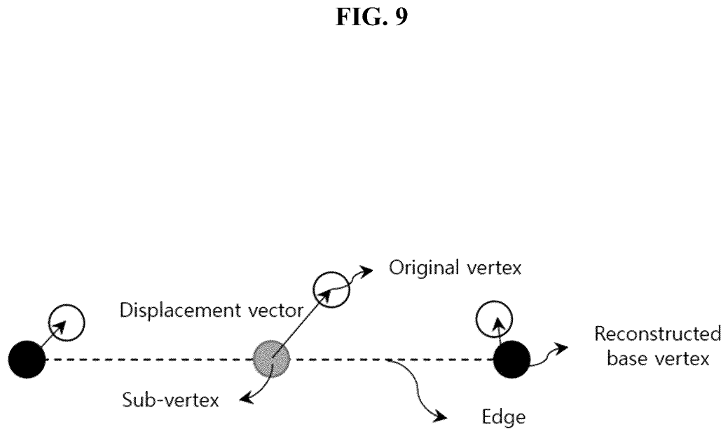

FIG. 9 is a diagram for describing a displacement vector according to an embodiment of the present disclosure.

Referring to FIG. 9, a sub-vertex generated through a mesh surface division unit may exist on an edge connecting two reconstructed base vertices. In this regard, a mid-point-based surface division method described above in FIG. 8 may be applied, but is not limited thereto.

A reconstructed base vertex including a sub-vertex may be mapped to an original vertex one-to-one. As an example, a preprocessing step before encoding/decoding may be processed so that an original vertex and a reconstructed vertex are mapped one-to-one.

As an embodiment, a displacement vector may be a three-dimensional vector expressing a difference between an original vertex and a reconstructed base vertex and/or sub-vertex. The geometry information of a mesh may be reconstructed by encoding and decoding a displacement vector and adding it to a reconstructed base vertex and/or sub-vertex.

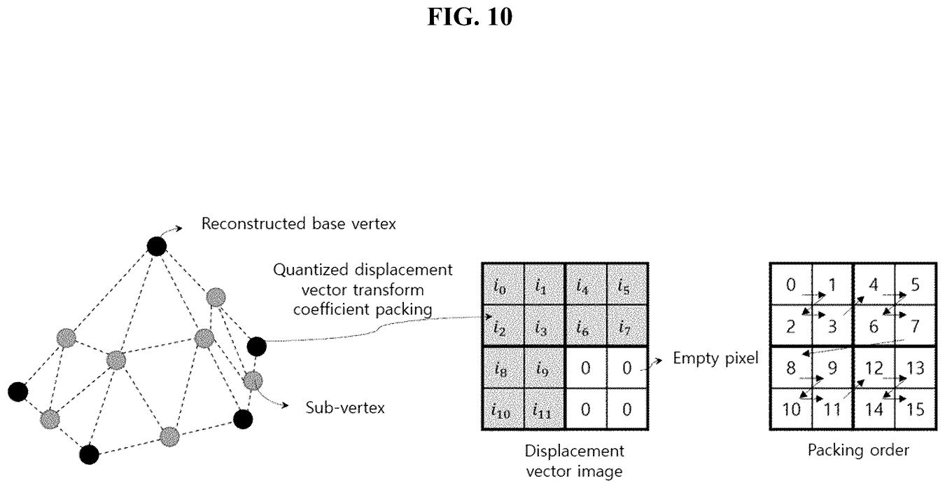

FIG. 10 is a diagram illustrating a coefficient scanning method of an image packing unit according to an embodiment of the present disclosure.

Referring to FIG. 10, as shown on the left of FIG. 10, a reconstructed base vertex and a surface-divided sub-vertex may have a quantized displacement vector transform coefficient for each vertex.

As an embodiment, a quantized displacement vector transform coefficient for each vertex may be packed according to predefined scan order to generate a displacement vector image. For example, as in a displacement vector image at the center of FIG. 10 and an example of packing order on the right, a quantized displacement vector transform coefficient for each vertex may be packed in Z-scan order in a 2×2-sized sub-region unit to generate a displacement vector image. Alternatively, a displacement vector transform coefficient may be packed in the reverse order of Z-scan order to generate a displacement vector image.

Here, the empty pixel of a displacement vector image may be filled with a specific value through a padding process in a padding unit. A specific value may be set as 0.

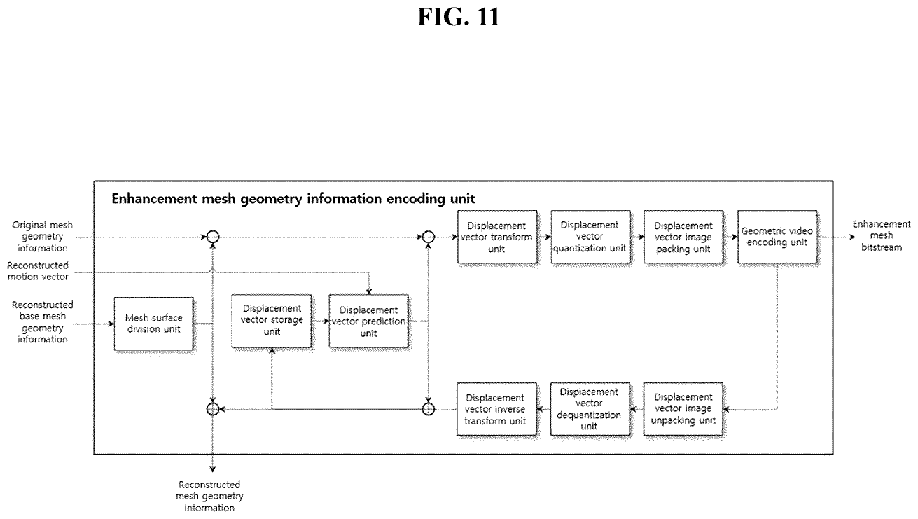

FIG. 11 is a diagram illustrating an enhancement mesh geometry information encoding unit according to an embodiment of the present disclosure.

Referring to FIG. 11, an enhancement mesh geometry information encoding unit may have a mesh surface division unit, a displacement vector storage unit, a displacement vector prediction unit, a displacement vector transform unit, a displacement vector quantization unit, a displacement vector image packing unit, a geometric video encoding unit, a displacement vector image unpacking unit, a displacement vector dequantization unit and a displacement vector inverse transform unit.

According to an embodiment of the present disclosure, an enhancement mesh geometry information encoding unit may receive original mesh geometry information, reconstructed base mesh geometry information and a reconstructed motion vector and perform encoding to generate an enhancement mesh bitstream and reconstructed mesh geometry information.

A mesh surface division unit may receive reconstructed base mesh geometry information and divide a mesh surface to generate divided mesh geometry information. In this regard, a mid-point-based surface division method described above in FIG. 8 may be applied, but is not limited thereto.

Divided mesh geometry information may be subtracted from input original mesh geometry information to generate a displacement vector and may be subtracted from a predicted displacement vector generated from a displacement vector prediction unit and input to a displacement vector transform unit in the form of a differential displacement vector. As an embodiment, a displacement vector may be generated based on a difference between the vertex of a divided mesh and the vertex of an original mesh. Then, prediction for a displacement vector may be performed. Encoding may be performed on a differential displacement vector representing a difference between a generated displacement vector and a predicted displacement vector. An encoding unit and a decoding unit may derive (or generate) a predicted displacement vector in the same manner. A decoding unit may derive a displacement vector for a vertex by combining a predicted displacement vector and a differential displacement vector.

In addition, divided mesh geometry information may be combined with a reconstructed differential displacement vector generated from a displacement vector inverse transform unit and a predicted displacement vector generated from a displacement vector predicton unit and output from an enhancement mesh geometry information encoding unit in the form of reconstructed mesh geometry information. In the present disclosure, a difference between divided mesh geometry information and original mesh geometry information may be referred to as an original displacement vector and a difference between an original displacement vector and a predicted displacement vector may be referred to as a differential displacement vector. In the present disclosure, a differential displacement vector may also be referred to as a residual displacement vector.

A displacement vector transform unit may transform an input displacement vector to generate a displacement vector transform coefficient. A generated displacement vector transform coefficient may be transmitted to a displacement vector quantization unit.

A displacement vector quantization unit may receive a transform coefficient and perform quantization to generate a quantized transform coefficient. A generated quantized transform coefficient may be transmitted to a displacement vector image packing unit.

A displacement vector image packing unit may generate a displacement vector image by packing a transmitted quantized displacement vector transform coefficient in the form of an image. A generated displacement vector image may be transmitted to a geometric video encoding unit.

A geometric video encoding unit may receive a combination of input displacement vector images in the form of a video and perform encoding to generate an enhancement mesh bitstream. A generated enhancement mesh bitstream may be output from an enhancement mesh geometry information encoding unit. In addition, a generated reconstructed displacement vector image may be transmitted to a displacement vector image unpacking unit.

A displacement vector image unpacking unit may unpack an input displacement vector image and reconstruct a quantized displacement vector transform coefficient. A generated quantized displacement vector transform coefficient may be transmitted to a displacement vector dequantization unit.

A displacement vector dequantization unit may perform dequantization by receiving an input quantized displacement vector transform coefficient to reconstruct a displacement vector transform coefficient. A reconstructed displacement vector transform coefficient may be transmitted to a displacement vector inverse transform unit.

A displacement vector inverse transform unit may reconstruct a displacement vector by inversely transforming an input reconstructed displacement vector transform coefficient. A reconstructed displacement vector may be combined with divided mesh geometry information generated from a mesh surface dividion unit to reconstruct mesh geometry information and may be output from an enhancement mesh geometry information encoding unit. In addition, a reconstructed displacement vector may be stored in a displacement vector storage unit.

A displacement vector storage unit may store the displacement vector of a current frame and transmit a stored displacement vector to a displacement vector prediction unit for displacement vector prediction in a subsequent frame.

A displacement vector prediction unit may receive a reconstructed motion vector and a reconstructed displacement vector to generate the predicted displacement vector of a current frame. A generated predicted displacement vector may be subtracted from an original displacement vector an transmitted to a displacement vector transform unit in the form of a differential displacement vector. In addition, a displacement vector may be reconstructed by being combined with a reconstructed differential displacement vector generated from a displacement vector inverse transform unit.

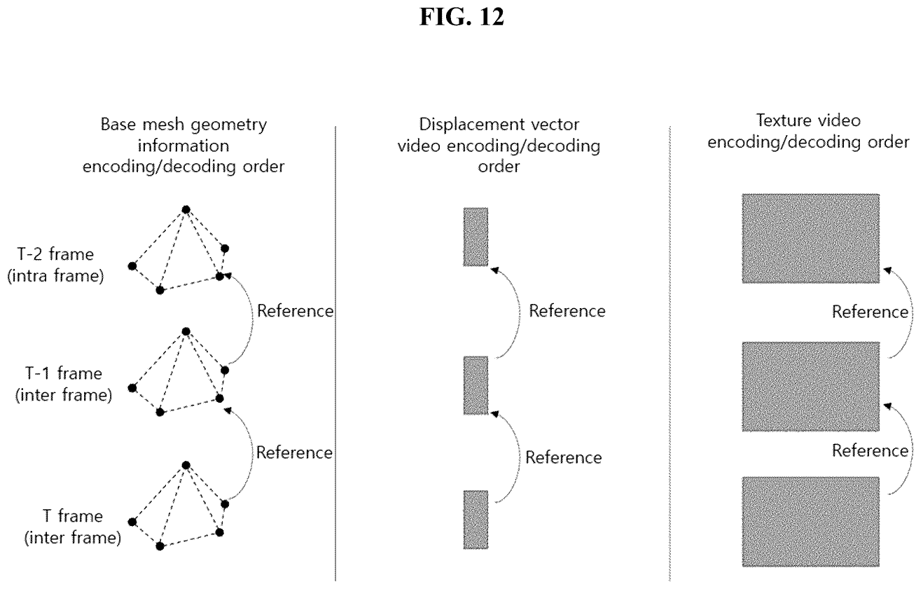

FIG. 12 is a diagram illustrating an enhancement mesh geometry information decoding unit according to an embodiment of the present disclosure.

Referring to FIG. 12, an enhancement mesh geometry information decoding unit may include a mesh surface division unit, a displacement vector prediction unit, a displacement vector storage unit, a geometric video decoding unit, an image unpacking unit, a displacement vector dequantization unit and a displacement vector inverse transform unit.

An enhancement mesh geometry information decoding unit may receive reconstructed base mesh geometry information, a reconstructed motion vector and an enhancement mesh bitstream to reconstruct mesh geometry information.

A mesh surface division unit may receive reconstructed base mesh geometry information and divide a mesh surface to generate divided mesh geometry information. Divided mesh geometry information may be subtracted from input original mesh geometry information to generate a displacement vector and may be subtracted from a predicted displacement vector generated from a displacement vector prediction unit and input to a displacement vector transform unit in the form of a differential displacement vector. In addition, divided mesh geometry information may be output from an enhancement mesh geometry information encoding unit in the form of reconstructed mesh geometry information by being combined with a reconstructed differential displacement vector generated from a displacement vector inverse transform unit and a predicted displacement vector generated from a displacement vector prediction unit.

A geometric video decoding unit may receive an enhancement mesh bitstream, reconstruct a displacement vector video and output it frame by frame in the form of a displacement vector image. A reconstructed displacement vector image may be transmitted to a displacement vector image unpacking unit.

A displacement vector image unpacking unit may unpack an input displacement vector image and reconstruct a quantized displacement vector transform coefficient. A generated quantized displacement vector transform coefficient may be transmitted to a displacement vector dequantization unit.

A displacement vector dequantization unit may perform dequantization by receiving an input quantized displacement vector transform coefficient to reconstruct a displacement vector transform coefficient. A reconstructed displacement vector transform coefficient may be transmitted to a displacement vector inverse transform unit.

A displacement vector inverse transform unit may reconstruct a displacement vector by inversely transforming an input reconstructed displacement vector transform coefficient. A reconstructed displacement vector may be combined with divided mesh geometry information generated from a mesh surface dividion unit to reconstruct mesh geometry information and may be output from an enhancement mesh geometry information encoding unit. In addition, a reconstructed displacement vector may be stored in a displacement vector storage unit.

A displacement vector storage unit may store the displacement vector of a current frame and transmit a stored displacement vector to a displacement vector prediction unit for displacement vector prediction in a subsequent frame.

A displacement vector prediction unit may receive a reconstructed motion vector and a reconstructed displacement vector to generate the predicted displacement vector of a current frame. In addition, a generated predicted displacement vector may be combined with a reconstructed differential displacement vector generated from a displacement vector inverse transform unit to reconstruct a displacement vector.

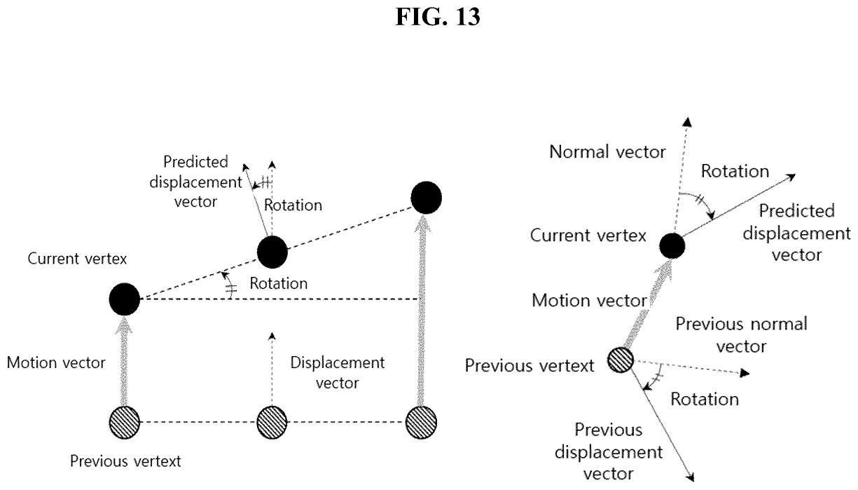

FIG. 13 is a diagram illustrating a displacement vector prediction method according to an embodiment of the present disclosure.

FIG. 13(A) illustrates a motion vector-based displacement vector rotation method and FIG. 13(B) illustrates a normal vector-based displacement vector rotation method.

Referring to FIG. 13, a predicted displacement vector may be generated by receiving a reconstructed motion vector and the displacement vector of a previous frame. In other words, a displacement vector prediction unit may generate a predicted displacement vector by using a motion vector and/or the displacement vector of a previous frame.

According to an embodiment of the present disclosure, a predicted displacement vector may be a vector in which the displacement vector of a previous frame is rotated. In other words, a predicted displacement vector for a current vertex may be a vector in which the displacement vector of a vertex corresponding to a current vertex in a previous frame is rotated based on a motion vector. In the present disclosure, a motion vector may be used to obtain (or derive) the geometry information (i.e., the position of a vertex) of a base mesh based on inter prediction (or inter-frame prediction). In other words, the position of a corresponding vertex of a previous frame (i.e., a vertex corresponding to a current vertex) and a motion vector may be used to determine the position of a current vertex in a current frame.

As an embodiment, rotation transform using an Euler's angle, quaternion-based rotation transform, etc. may be used as a rotation transform method of a displacement vector. In this case, a transform parameter required for rotation transform may be calculated based on a motion vector as in FIG. 13(A). In addition, as another embodiment, a rotation transform parameter may be calculated (or obtained) based on a normal vector.

As an embodiment, a method for obtaining a rotation transform parameter may be selectively used according to whether a current vertex is a base vertex. In the present disclosure, a base vertex may refer to a vertex of a base mesh. If a current vertex is a vertex of a base mesh, it is not on the same three-dimensional plane as neighboring vertices, so normal vector (or normal vector)-based rotation may be used. If a current vertex is a sub-vertex generated by performing surface division on a base mesh, it is on the same three-dimensional plane as neighboring base vertices, so a rotation transform parameter may be obtained based on the motion vector of a neighboring base vertex. In this case, a neighboring base vertex may mean three base vertices used to generate a current sub-vertex. A rotation transform parameter for predicting the displacement vector of a current sub-vertex may be obtained based on the motion vector of a neighboring base vertex. Alternatively, a rotation transform parameter may be obtained by using the motion vector of neighboring sub-vertices calculated based on the motion vector of a base vertex.

As another embodiment, rotation transform may be selectively performed based on the size value of a motion vector. For example, when the size value of a motion vector is less than or less than or equal to a specific value, rotation transform may be not performed. Conversely, when the size value of a motion vector exceeds or is greater than or equal to a specific value, rotation transform may be performed. Alternatively, rotation transform may be selectively performed based on a difference between motion vectors of an adjacent vertex. In other words, rotation transform may be performed only when a difference between motion vectors of an adjacent vertex is greater than or greater than or equal to a predefined value.

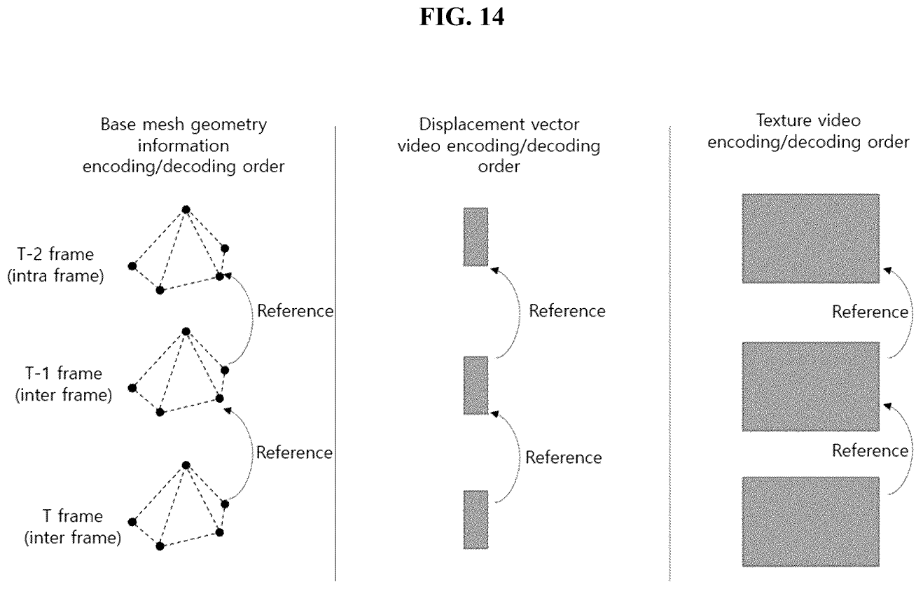

FIG. 14 is a diagram illustrating an encoding/decoding order and reference structure of base mesh geometry information, a displacement vector image and a texture image according to an embodiment of the present disclosure.

As in an example of FIG. 14, mesh geometry information, a displacement vector video (or image) and a texture video (or image) may be sequentially encoded/decoded. In this case, for inter prediction, pre-reconstructed geometry information, displacement vector and attribute information may be used to perform encoding/decoding, respectively.

According to an embodiment of the present disclosure, geometry information, a displacement vector video and a texture video may use different prediction for each coding unit. For example, a displacement vector video and a texture video may perform intra prediction and/or inter prediction in a specific processing unit according to the coding unit and mode of a video compression method. In the present disclosure, a coding unit may be a processing unit in which a prediction method (or a prediction mode) is determined. As an example, the coding unit of geometry information may be at least one of a frame, a patch, a triangle (or a surface) and a vertex.

For example, when a coding unit is a frame, reference frame information may be transmitted from an encoder to a decoder. Alternatively, when a coding unit is a patch, reference frame information and reference patch information may be transmitted from an encoder to a decoder. Alternatively, when a coding unit is a triangle, reference frame information, reference patch information, reference triangle information, etc. may be transmitted from an encoder to a decoder. Alternatively, when a coding unit is a vertex, reference frame information, reference patch information, reference triangle information and reference vertex information may be transmitted from an encoder to a decoder.

As an embodiment, a displacement vector video and a texture video may have a different reference structure because they perform encoding/decoding by using the existing video compression standard technology. An example in FIG. 14 is an example of a structure in which both videos refer to a single frame reconstructed immediately before for low-latency encoding/decoding.

As an example, base mesh geometry information may have a different reference structure from a displacement vector video and/or a texture video. For example, for an inter prediction mode, base mesh geometry information may perform inter prediction on the entire frame geometry information. On the other hand, a displacement vector and a texture video may perform intra or inter prediction in a coding block unit within a video encoding/decoding device.

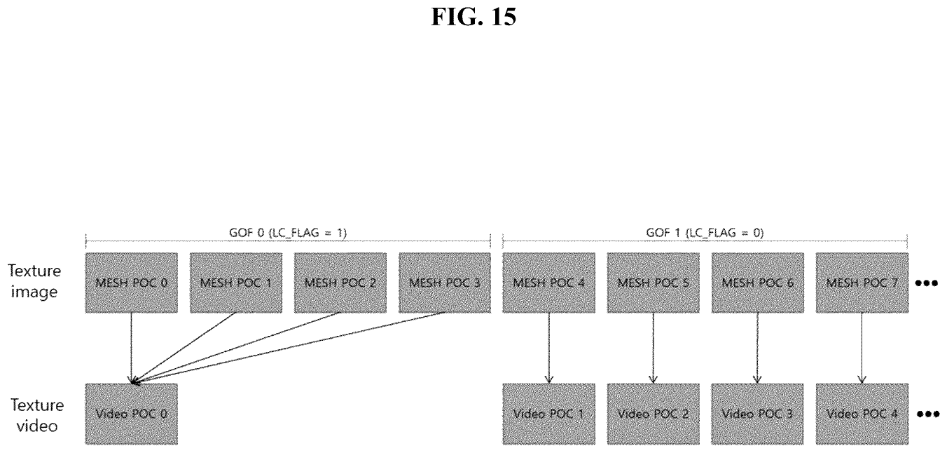

FIG. 15 is a diagram illustrating an encoding/decoding process of a texture video according to an embodiment of the present disclosure.

Referring to FIG. 15, the texture image of a mesh may exist in all mesh Picture Order Counts (POC). In other words, each mesh may be allocated a POC value and each mesh may have a texture image.

In this case, even when a three-dimensional object moves, the attribute information of an external surface of an object may be similar. Accordingly, according to an embodiment of the present invention, considering this, compression encoding may be performed on a texture image in a unit of a frame or a frame group.

As an embodiment, a predetermined frame group GOF (Group Of Frame) may be defined. In a GOF unit, a texture video may be generated with a smaller number of texture images than the size of a GOF and based thereon, encoding/decoding may be performed. As an example, information about a GOF size may be transmitted to a decoder through entropy encoding as high-level information.

As an embodiment, a texture video may be generated by using only first texture images in a GOF unit. A decoder may obtain a GOF size from high-level information and use one transmitted texture image in all frames of a corresponding GOF.

As an example, a method for encoding/decoding a smaller number of textures than a GOF size may be selectively used in a GOF unit. In other words, whether to apply a texture image compression method according to the present embodiment may be determined in a GOF unit. For example, LC_FLAG, a flag related to the use of a method for encoding/decoding a smaller number of textures than a GOF size, may be defined. In other words, a flag indicating whether GOF unit texture image compression is used may be defined and in the present disclosure, a corresponding flag may be referred to as LC_FLAG. LC_FLAG may be transmitted to a decoder through entropy encoding.

For example, when a LC_FLAG value is 1, GOF unit texture image compression may be used and when a LC_FLAG value is 0, GOF unit texture image compression may not be used. As shown in FIG. 15, meshes included in a GOF with a LC_FLAG value of 1 may be reconstructed by using a texture image having a predetermined POC value in a texture video. For meshes included in a GOF with a LC_FLAG value of 0, a corresponding texture image may be included in a texture video and reconstructed by using it. In other words, a decoder may reconstruct a mesh by partially referring to a texture image from a texture video received by checking a corresponding flag in a GOF unit.

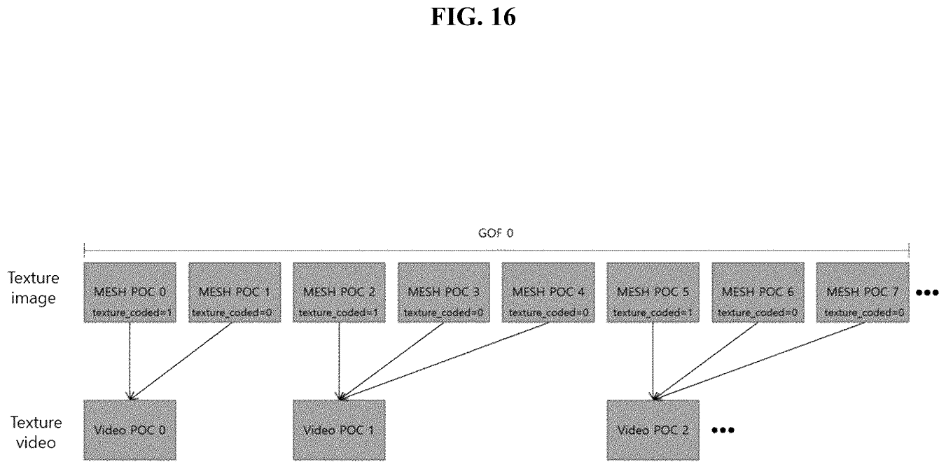

FIG. 16 is a diagram illustrating an encoding/decoding process of a texture video according to an embodiment of the present disclosure.

Referring to FIG. 16, each frame (i.e., a mesh, a mesh frame) of a specific GOF may define a flag indicating whether a texture image for a current frame is coded. In the present disclosure, a corresponding flag may be referred to as a texture coding flag or a texture_coded flag. In other words, in FIG. 16, texture_coded represents a texture coding flag.

As an embodiment, when a texture coding flag is 1, the texture image of a current mesh may be encoded by being included in a texture video. Conversely, when a texture coding flag is 0, encoding for the texture image of a current mesh may be omitted. When a texture coding flag is 0, encoding for the texture image of a current mesh may be omitted and the texture image of a previous mesh may be referenced. In other words, when a texture coding flag is 0, encoding for the texture image of a current mesh may be omitted and a current mesh may be encoded/decoded by using a reference texture image.

Texture coding information may be included in high-level information in a mesh frame unit and signaled to a decoder through entropy encoding. A decoder may check corresponding information in a mesh frame unit to reconstruct a texture image.

As an example, when a texture coding flag value is 0, the texture image of a mesh frame with a texture coding flag value of 1 and a POC value closest to the POC of a current mesh frame among the pre-reconstructed mesh frames may be used as a current texture image. In other words, when a texture coding flag value is 0, the texture image of a mesh frame with the closest POC value among the pre-reconstructed mesh frames may be referenced.

In addition, in an embodiment, a texture coding flag may be used (or signaled) only when the LC_FLAG of a current GOF is 1. As another example, when the prediction mode of a current mesh frame is an intra prediction mode, encoding/decoding for a texture coding flag may be omitted and its value may be derived (or inferred) as 1.

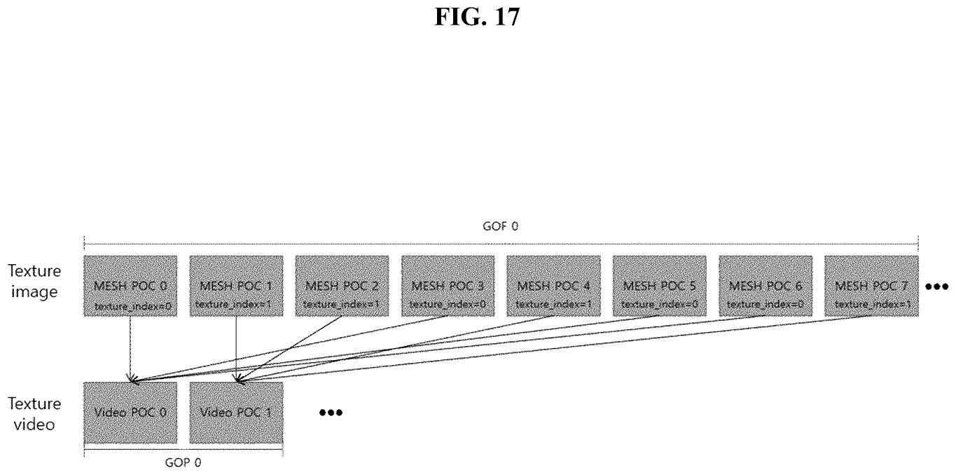

FIG. 17 is a diagram illustrating an encoding/decoding process of a texture video according to an embodiment of the present disclosure.

Referring to FIG. 17, a reference texture image may be determined in a mesh frame unit. In an embodiment of the present disclosure, a Group Of Picture (GOP), which is a predetermined texture image group, may be defined. A texture video may include a GOP. In other words, the texture image (i.e., reference texture image) of a current mesh may be specified within the GOP of a texture video in each mesh frame unit. As an embodiment, a reference texture image within the GOP of a texture video may be specified by a frame index. In the present disclosure, a frame index specifying a reference texture image within the GOP of a texture video may be referred to as a frame index, a texture index or a texture image index.

For example, when the GOP size of a texture video is 2, a texture index (texture_index in FIG. 17) may have a value of 0 and 1. When it is 0, it may mean that a first frame within a GOP is used as the texture image of a current MESH POC in a texture video. Conversely, when it is 1, it may mean that a second frame inside a GOP is used as the texture image of a current MESH POC in a texture video.

In an embodiment, one texture video frame may be generated by gathering original texture images with the same texture index. Alternatively, an image with the smallest MESH POC value among the same original texture images may be used as a texture video frame. A texture index may be included in high-level information in each mesh frame unit and transmitted to a decoder through entropy encoding. In addition, in an embodiment, a texture index may be used (or signaled) only when the LC_FLAG of a current GOF is 1.

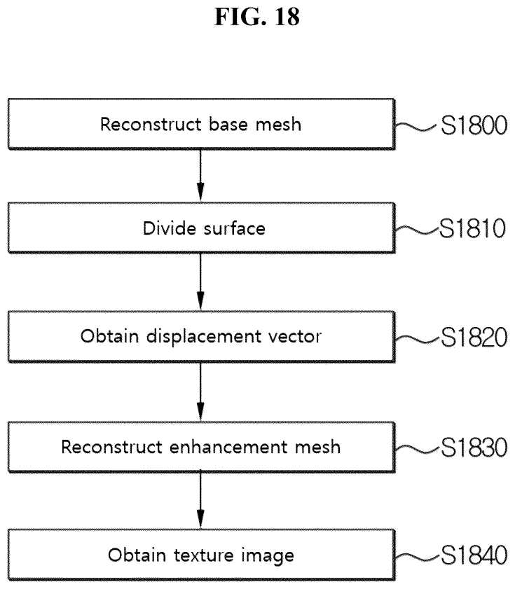

FIG. 18 is a flowchart illustrating a mesh compression process according to an embodiment of the present disclosure.

Referring to FIG. 18, in describing a mesh compression method, a method performed by a mesh decoder is mainly described, but is not limited thereto, and a method described in the present embodiment may be performed by a mesh encoder in a substantially identical manner. A method described in FIGS. 1 to 17 above may be applied to the present embodiment.

A mesh decoder may reconstruct a base mesh based on geometry information obtained from a base mesh bitstream S1800.

A mesh decoder may perform surface division on a reconstructed base mesh S1810.

A mesh decoder may obtain a displacement vector for at least one of a vertex of the reconstructed base mesh and a sub-vertex generated by surface division S1820.

A mesh decoder may reconstruct an enhancement mesh based on a reconstructed base mesh and an obtained displacement vector (S1830).

A mesh decoder may obtain a texture image associated with the surface of a reconstructed enhancement mesh S1840. A mesh decoder may reconstruct a current frame based on the reconstructed enhancement mesh and the texture image.

As described above, the geometry information may be coded based on a first prediction mode, the displacement vector may be coded based on a second prediction mode and the texture image may be coded based on a third prediction mode. The first prediction mode, the second prediction mode and the third prediction mode may be one of an inter prediction mode or an intra prediction method.

In addition, as described above, at least one of the first prediction mode, the second prediction mode or the third prediction mode may be determined in a predetermined coding unit. As an example, the coding unit may be at least one of a frame, a patch, a surface or a vertex.

In addition, as described above, a mesh decoder may obtain a first flag indicating whether texture image compression is used for a current frame. Here, the first flag may be signaled in a frame group unit including at least one frame. When the texture image compression is used for the current frame, a texture image obtained in S1840 may be obtained by referring to the texture image of a frame coded before the current frame. With this regard, the content described in FIG. 15 above may be applied, wherein an overlapping description is omitted.

In addition, as described above, a mesh decoder may obtain a second flag indicating whether to code a texture image for the current frame. The second flag may be signaled in a frame unit. When the coding of a texture image for the current frame is omitted, the texture image may be obtained by referring to the texture image of a frame where a picture order count (POC) value is closest to the current frame among the frames coded before the current frame. With this regard, the content described in FIG. 16 above may be applied, wherein an overlapping description is omitted.

In addition, as described above, a mesh decoder may obtain a texture index indicating a texture image in a texture video including a plurality of texture images in the step of obtaining the texture image. With this regard, the content described in FIG. 17 above may be applied, wherein an overlapping description is omitted.

Embodiments described above may be a combination of components and features of the present disclosure in a predetermined form. Each component or feature should be considered selective unless explicitly stated otherwise. Each component or feature may be implemented in a form which is not combined with other component or feature. In addition, some components and/or features may be combined to configure an embodiment of the present disclosure. Order of operations described in embodiments of the present disclosure may be changed. Some configurations or features of an embodiment may be included in other embodiment or may be replaced with a configuration or a feature corresponding to other embodiment. It is obvious that claims without an explicit citation relationship in a scope of claims may be combined to configure an embodiment or may be included as a new claim by amendment after application.

An embodiment according to the present disclosure may be implemented by a variety of means, for example, hardware, firmware, software, or a combination thereof, etc. For implementation by hardware, an embodiment of the present disclosure may be implemented by one or more ASICs (application specific integrated circuits), DSPs (digital signal processors), DSPDs (digital signal processing devices), PLDs (programmable logic devices), FPGAs (field programmable gate arrays), processors, controllers, micro controllers, micro processors, etc.

In addition, for implementation by firmware or software, an embodiment of the present disclosure may be implemented in a form of a module, a procedure, a function, etc. performing functions or operations described above and may be recorded in a readable recoding medium through a variety of computer means. Here, a recording medium may include a program instruction, a data file, a data structure, etc. alone or in combination. A program instruction recorded in a recording medium may be those specially designed and configured for the present disclosure or those available by being notified to a person skilled in computer software. For example, a recording medium includes magnetic media such as a hard disk, a floppy disk and a magnetic tape, optical media such as CD-ROM (Compact Disk Read Only Memory) and DVD (Digital Video Disk), magneto-optical media such as a floptical disk and a hardware device which is specially configured to store and perform a program instruction such as ROM, RAM, a flash memory, etc. An example of a program instruction may include a high-level language code which may be executed by a computer by using an interpreter, etc. as well as a machine language code like what is made by a compiler. Such a hardware device may be configured to operate as at least one software module to perform an operation of the present disclosure and vice versa.

In addition, a device or a terminal according to the present disclosure may be driven by a command which causes at least one processor to perform functions and processes described above. For example, such a command may include, for example, an interpreted command like a script command such as a JavaScript or ECMAScript command, etc. or other commands stored in a computer readable medium readable or an executable code. Further, a device according to the present disclosure may be implemented in a distributed way across a network such as Server Farm or may be implemented in a single computer device.

In addition, a computer program which comes with a device according to the present disclosure and executes a method according to the present disclosure (also known as a program, software, a software application, a script or a code) may be written in any form of a programming language including a compiled or interpreted language or a priori or procedural language and may be deployed in any form including a stand-alone program, module, component or subroutine or other units suitable for use in a computer environment. A computer program does not necessarily correspond to a file of a file system. A program may be stored in a single file provided for a requested program, or in multiple interacting files (e.g., a file storing part of at least one module, subprogram or code), or in part of a file owning other program or data (e.g., at least one script stored in a markup language document). A computer program may be positioned in one site or distributed across a plurality of sites and may be deployed to be executed on one computer or multiple computers interconnected by a communication network.

It is obvious to a person skilled in the art that the present disclosure may be implemented in other specific form without departing from an essential feature of the present disclosure. Accordingly, the above-described detailed description should not be interpreted restrictively in all respects and should be considered illustrative. A scope of the present disclosure should be determined by reasonable interpretation of attached claims and all changes within an equivalent scope of the present disclosure are included in a scope of the present disclosure.

### INDUSTRIAL AVAILABILITY

The present invention may be used in mesh compression method and device.

1. A mesh compression method, comprising:
reconstructing a base mesh based on geometry information obtained from a base mesh bitstream;
performing a surface division on the reconstructed base mesh;
obtaining a displacement vector for at least one of a vertex of the reconstructed base mesh and a sub-vertex generated by the surface division;
reconstructing an enhancement mesh based on the reconstructed base mesh and the obtained displacement vector; and
obtaining a texture image associated with a surface of the reconstructed enhancement mesh.

2. The method of claim 1, wherein the geometry information is coded based on a first prediction mode, the displacement vector is coded based on a second prediction mode, and the texture image is coded based on a third prediction mode.

3. The method of claim 2, wherein the first prediction mode, the second prediction mode, and the third prediction mode are one of an inter prediction mode or an intra prediction method.

4. The method of claim 2, wherein at least one of the first prediction mode, the second prediction mode, or the third prediction mode is determined in a predetermined coding unit.

5. The method of claim 4, wherein the coding unit is at least one of a frame, a patch, a surface or a vertex.

6. The method of claim 1, further comprising:
reconstructing a current frame based on the reconstructed enhancement mesh and the texture image.

7. The method of claim 6, further comprising:
obtaining a first flag indicating whether a texture image compression is used for the current frame.

8. The method of claim 7, wherein the first flag is signaled in a frame group unit including at least one frame.

9. The method of claim 7, wherein when the texture image compression is used for the current frame, the texture image is obtained by referring to a texture image of a frame coded before the current frame.

10. The method of claim 6, further comprising:
obtaining a second flag indicating whether to code a texture image for the current frame.

11. The method of claim 10, wherein the second flag is signaled in a frame unit.

12. The method of claim 10, wherein when a coding of the texture image for the current frame is omitted, the texture image is obtained by referring to a texture image of a frame that a picture order count (POC) value is closest to the current frame among frames coded before the current frame.

13. The method of claim 1, wherein obtaining the texture image includes obtaining a texture index indicating a texture image in a texture video including a plurality of texture images.

14. A mesh compression device, comprising:
a processor controlling the mesh compression device; and
a memory connected to the processor and storing data,
wherein the processor:
reconstructs a base mesh based on geometry information obtained from a base mesh bitstream,
performs a surface division on the reconstructed base mesh,
obtains a displacement vector for at least one of a vertex of the reconstructed base mesh and a sub-vertex generated by the surface division,
reconstructs an enhancement mesh based on the reconstructed base mesh and the obtained displacement vector, and
obtains a texture image associated with a surface of the reconstructed enhancement mesh.
